(19) United States
(12) Patent Application Publication
(10) Pub. No.: US 2003/0170598 A1
(43) Pub. Date: Sep. 11, 2003

(54) Computer assisted method for memory training

(76) Inventor: David Boggs, Montecito Heights, CA (US)

Correspondence Address: I. Michael Bak-Boychuk, Attorney at Law, P.O. Box 32501, Long Beach, CA, 90832, US

(21) Appl. No.: 10/194,118

(22) Filed: Jul. 12, 2002

Related U.S. Application Data
(63) Continuation-in-part of application No. 10/092,060, filed on Mar. 5, 2002.

(51) Int. Cl. G09B 19/00

(52) U.S. Cl. 434/236; 434/323; 434/362

(57) ABSTRACT

A computer network enabled process is devised in which the memory faculties of the contestants are exercised by viewing a sequential set of randomly generated symbol groupings for a first interval of time and thereafter the specific symbols and their groupings are to be recreated on a further screen image in a second interval of time. The symbol groupings may be inscribed on images of the faces of a set of virtual flash cards which are uniformly random. The cards are revealed for the first time interval and following a delay or immediately thereafter the contestants are directed to recreate correctly the symbols and their groupings during the second time interval. The number of symbols groupings correctly recalled comprises the score.

### REFERENCE TO RELATED APPLICATIONS

This application is a continuation-in-part of the matter disclosed in U.S. application Ser. No. 10/092,060 filed on Feb. 14, 2002. Applicant claims the benefit of this earlier filing date for all matter common to this earlier application.

### BACKGROUND OF THE INVENTION

1. Field of the Invention

The present invention relates to teaching aids, and more particularly to a method and apparatus for training human memory processes.

2. Description of the Prior Art

The use of flash cards as a training aid in the early stages of schooling has been known in the past, exemplified by flash cards designed to evoke certain sound patterns corresponding to the letters of the alphabet, word flash cards to promote correct spelling, numerical flash cards to memorize multiplication table, and so on. The association of flash cards with our learning processes is therefore well established. To further enhance interest and thus the efficacy of the learning process various methods and structures have been devised which combine flash cards in a game sequence such as the card games for learning the alphabet described in U.S. Pat. Nos. 6,276,940 to White, 5,524,899 to Haqedorn, 5,906,492 to Putterman and others. In each instance the flash card is used to indicate, and reinforce, an association between the characters or symbols on the card and some fact or word. Thus the primary utility of the flash card process is reinforcement of particular mental associations which only collaterally also reinforce the general facility of committing facts to memory.

Those in the art are familiar with the various analogs postulated for the human mind including those models that suggest a self coding process in which logical junctions are effectively formed along the path of conduction associated with a favored response. With repetition this analogical process refines and enlarges the number of junctions and thus refines the record of the information stored. This model, however, is best associated with logical organization and retention of information, or learning, and not with the speed at which such retention is effected, i.e., one mental attribute while most current thinking recognizes two central attributes of the physical brain in which the first, referred to above, is related to the quantity of material available for creating the junctions while the second relates to the efficiency of the junction forming process. Amongst these two functions the prior art flash card techniques favor the first, the junction forming process which is then further granulated and refined by the perceived logical nature of the association and even the architecture of the storage process itself, e.g., the architecture of speech. The second attribute related to the general facility with which junctions are formed has had little attention in the prior art.

The working or short term memory of a human brain entails processes that are often associated with one's state of health, age and mental well-being. Idioms and homilies like ‘senior moment’, ‘absent-minded professor’ and the like amply summarize the general observation that this part of one's mental faculties is subject to deterioration. Of course, the observations that have led to these general conclusions appear to be based on correct scientific underpinnings as recently supported in the separate works of Drs. Arvid Carlsson, Paul Greengard and Eric Kandel for which they shared the 2000 Nobel Prize in Physiology and Medicine. In essence Drs. Carlsson and Greengard found the chemical nature of all mental processes while Dr. Kandel confirmed this in his work focusing on heightened short term or working memory persistence that can be obtained through stress sensitization. The works of Drs. Carlsson and Greengard are now fully confirmed by the introduction of drugs like Prozac and L-dopa which the brain effectively converts to serotonin and dopamine. Dr. Kandel's work then carried further Dr. Greengard’s phosphorylation deductions as the molecular basis for short term memory.

Thus there is now substantial confirmation of the junction analog for long term memory model of the human brain and the associative exercises of the current flash card teaching aids are well supported. Short term, or working, memory enhancement, however, has had little attention in the prior art and it is one such enhancement process that is described herein.

### SUMMARY OF THE INVENTION

Accordingly, it is the general purpose and object of the present invention to provide a flash card memory exercise process in which the flash card images have no logical associative symbolism.

Other objects of the invention are to provide a short term or working memory exercise method in which various features of a plurality of flash cards are combined with flash card symbols having no logical association are combined and permutated to produce a large combinatorial result from any randomizing process like card shuffling.

Yet further objects of the invention are to provide a computer assisted memory training method useful in enhancing short term memory facility.

Additional objects of the invention are to provide a short term memory training method which is enhanced in its effects by the stress enhancing aspects of a contest.

Briefly, these and other objects are accomplished within the present invention by providing a set of flash cards each of a planform identical to the others and each of dimensions convenient for manual shuffling. One face of each flash card is then inscribed with a plurality of symbols randomly selected from a symbol set that includes a subset of vertically symmetrical symbols and a further subset that are not symmetrical. For example symbols that approximate the shape of the letter X or Z are vertically symmetrical as are symbols in the shape of a circle, a diamond or a square. Symbols following the shape of the letter W, however, are not and therefore are identified as an M or W depending on the orientation of the flash card as it is displayed. Other geometric symbols like a triangle or a five cornered star that are also vertically asymmetric are also useful within the present invention, providing further combination and permutation variety. Even further variety is obtained by way of randomly selected colors that are used to imprint each of the symbols.

The foregoing symbols may be randomly combined in groups of two, three, four or more symbols on the face of the flash cards which are then shuffled and dealt face up, in groups of two, three or more, into a particular concealment box assigned to corresponding contestants. The dealt cards in each of the concealment box are then exposed for a common first time period to each of the contestants who then have to precisely describe within a second time period each of the cards by way of the symbols thereon, their color, polarity and so on. Points are then awarded to the contestants depending on the number of cards correctly described. In this manner a limited card set can be effectively utilized in the course of many game repetitions to provide the necessary exercise stimulus to the short term or working memory of the contestants.

The interval between the first period and the second period can be varied and may be increased as the memory facility of the contestants improves. Thus varying levels of temporal proximity can be tested in a process that is easily implemented and conveniently carried out.

The same methodology can be implemented in a computerized process in which a random number generating application can be used to select the symbol combinations on a single card that is then displayed on a monitor screen for a controlled interval of time. Other randomly selected symbol combinations can then be displayed in the next succeeding time intervals until the specified number of cards is displayed. The participant must then identify the symbol combinations within a given recall interval to obtain a score.

This computer assisted process may be effected on a network where a central server provides the random number generator functions, the card display sequence and the subsequent recall scoring. In this manner a universal standard of performance is imposed on all those choosing to participate.

### BRIEF DESCRIPTION OF THE DRAWINGS

FIG. 1 is a perspective illustration, separated by parts, of the array of parts and devices useful in carrying out the inventive process;

FIGS. 2a through 2c are each an illustration of one exemplary flash card useful in the inventive process described herein;

FIG. 3 is a sequence diagram illustrating the sequence of steps effected in accordance with the inventive short term memory exercise process described herein;

FIG. 4 is a diagrammatic illustration of a computer network arrangement useful with the present invention;

FIG. 5 is a flow chart illustrating the sequence of logical operations effected on the system shown in FIG. 4 in order to carry out the inventive mental exercise process described herein; and

FIGS. 6 and 7 are each illustrations of a monitor screen image in accordance with the present invention.

### DESCRIPTION OF THE PREFERRED EMBODIMENT

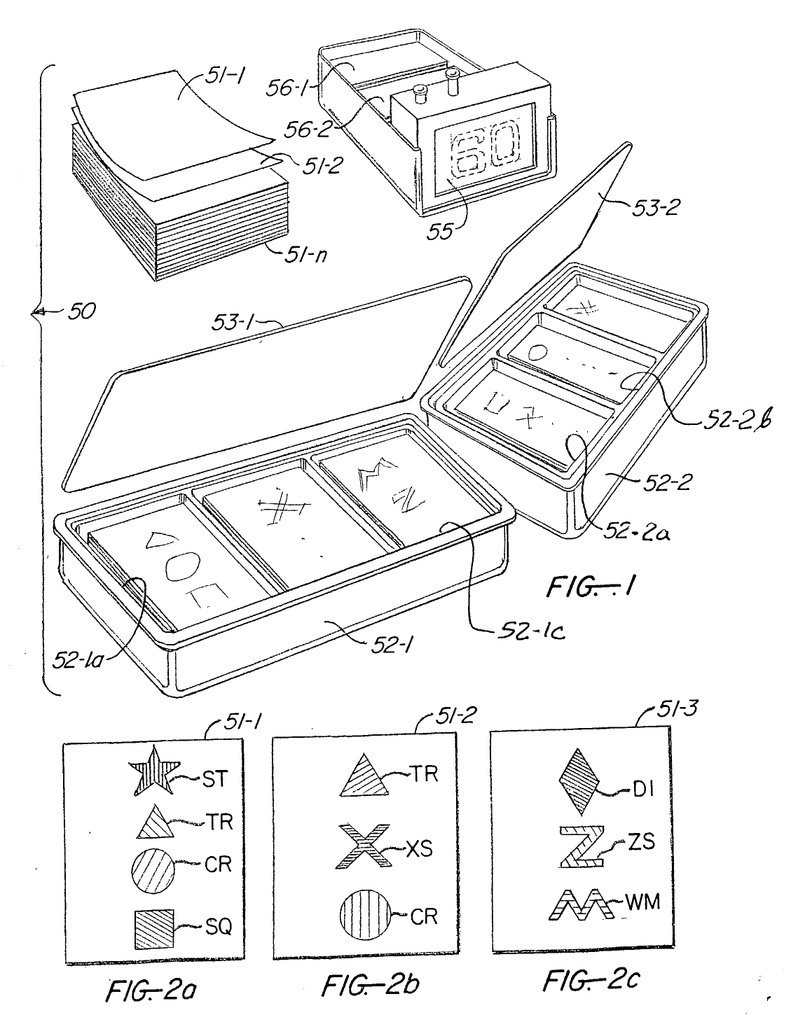

As shown in FIGS. 1 through 3 the inventive short term memory exercise sequence generally illustrated by the numeral 10, is effected with the use of an array 50 of articles and devices including a deck of flash cards 51-1 through 51-n each of a common planform substantially similar to the planform of playing cards, a first and second contestant's tray 52-1 and 52-2 each divided into a plurality of card receiving depressions 52-1a, b and c and 52-2a, b and c and a corresponding cover 53-1 and 53-2 dimensioned for placement over the trays to cover and conceal such cards as may have been placed into the depressions. Also included in the array is a stop watch or timer 55 and contestants' notepads 56-1 and 56-2 on which the contestants may inscribe such answers as are required in the course of the short term memory exercise sequence described hereinbelow.

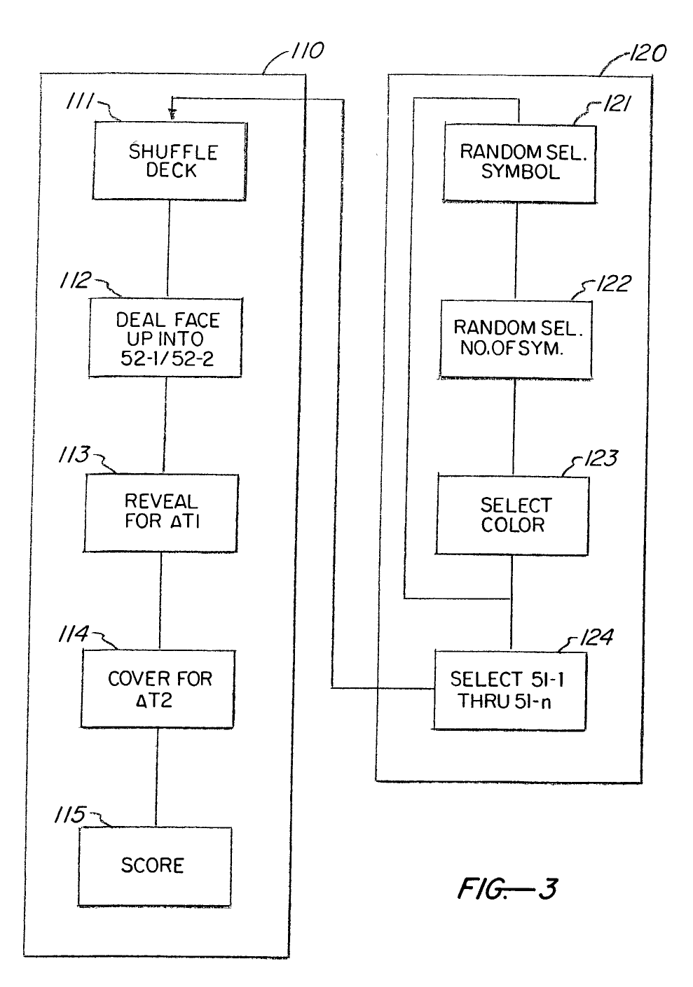

Each of the cards 51-1 through 51-n is inscribed on one face thereof with a group of randomly chosen symbols selected in combination and permutation groups of two, three or four from subsets of vertically symmetrical symbols, vertically asymmetrical symbols and various color subsets. For example the symmetrical symbol set may comprise squares SQ, circles CR, diamond shapes DI, and shapes approximating the letter x XS or z ZS while the asymmetrical subset may include triangles TR, star shapes ST and symbols approximating the shape of w or m WM. As exemplified in FIGS. 2a, b and c the group of symbols randomly selected on the face of the dealt card 51-1 includes the asymmetrical star symbol ST, the asymmetrical triangle symbol TR, a circle CR and a square SQ. In FIG. 2b card 51-2 is, in turn, exemplified by symbols TR, XS and CR and in FIG. 2c the symbols DI, ZS and WM are shown inscribed on the face of card 51-3. Thus each of these three examples illustrates a vertically asymmetrical symbol grouping with the asymmetric alignment in the corresponding tray depressions 52-1a, b and c and 52-2a, b and c determining the symbol identification. Of course, randomly selected symbol combinations can also include a wholly symmetrical grouping of symbols. In addition to the foregoing combination and permutation variables there can be a further expanded by color. Thus the card symbols identified above can be further expanded in detail by selecting one of the colors like purple, orange, yellow, red, blue, green or black.

It will be appreciated that all the foregoing variables are randomly combined in the above mentioned groupings of two, three or four symbols on a card. Of course, the number of combinations, permutations and variations that is thereby obtainable is extremely large and there is therefore a large number of card groupings that can effectively be collected into a single deck. The selection of the deck including cards 51-1 through 51-n is thus not limited by the limits of combination but is simply determined by the by their manipulative convenience where a number of around seventy appears to best serve this requirement. The purely random interrelationship of the symbols, however, assures an illogical symbol association, thus suppressing those mental processes associated with learning or long term memory organization and leaving only those facilities that combine in short term or working memory. Of course, this large pool of available further card decks discourages efforts at recalling any particular pattern

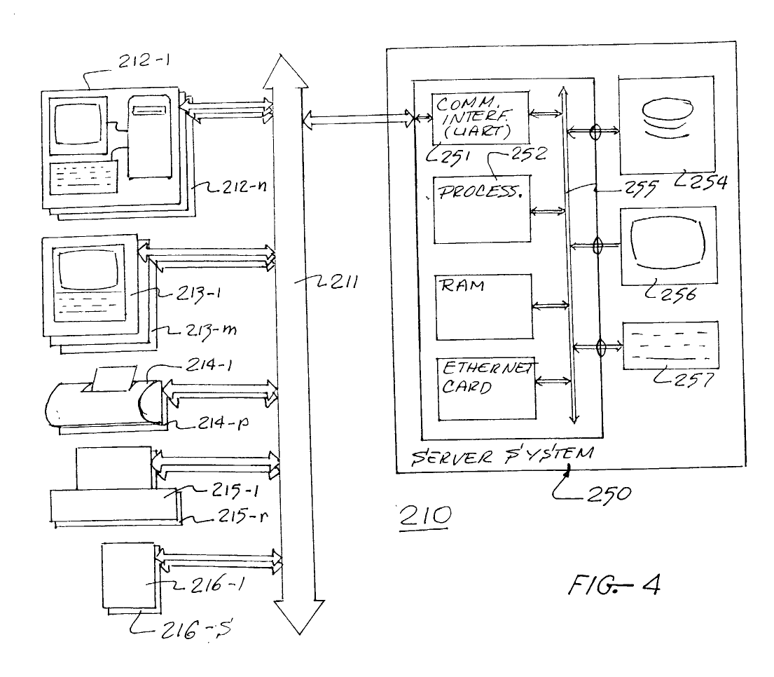

By particular reference to FIG. 3 the inventive short term memory exercise process generally designated by the numeral 110 commences with step 111 in which the deck comprising cards 51-1 through 51-n is fully shuffled, face down, and thereafter cards are dealt from the top and face up, in step 112, into the corresponding depressions a, b and c of the respective trays 52-1 and 52-2 and then covered by the corresponding covers 53-1 and 53-2. In step 113 both the covers are lifted for a first time interval determined by timer 55, for example sixty seconds, and the dealt cards are then revealed to the contestants. At the end of this first time interval both the trays are covered again in step 114 and the contestants then must describe the contents of their respective tray during the course of a second time interval. This test of recollection may follow immediately step 113 or may be delayed by varying periods as the contestants facility at recollection is improved by repeated exercise. Then in step 115 the correctly identified cards are each accumulated and a score is awarded to the contestant from which a win or a loss is determined. In this manner the positive stressing functions of a contest are utilized to exercise the working or short term memory of each participant.

It will be appreciated that the foregoing steps take benefit of a purely randomized symbol combinations effected by the use of any commercially available random number generation technique. Thus the sequence 110 may be nested in a sequence 120 which in step 121 randomly selects the symbol, in step 122 randomly selects the number of symbols to be applied on the particular card and in step 123 randomly selects the color therefor. Then in step 124 a deck comprising cards 51-1 through 51-n is randomly selected from the total cards thus generated. This purely random process confines the above contest to an exercise of the working memory only.

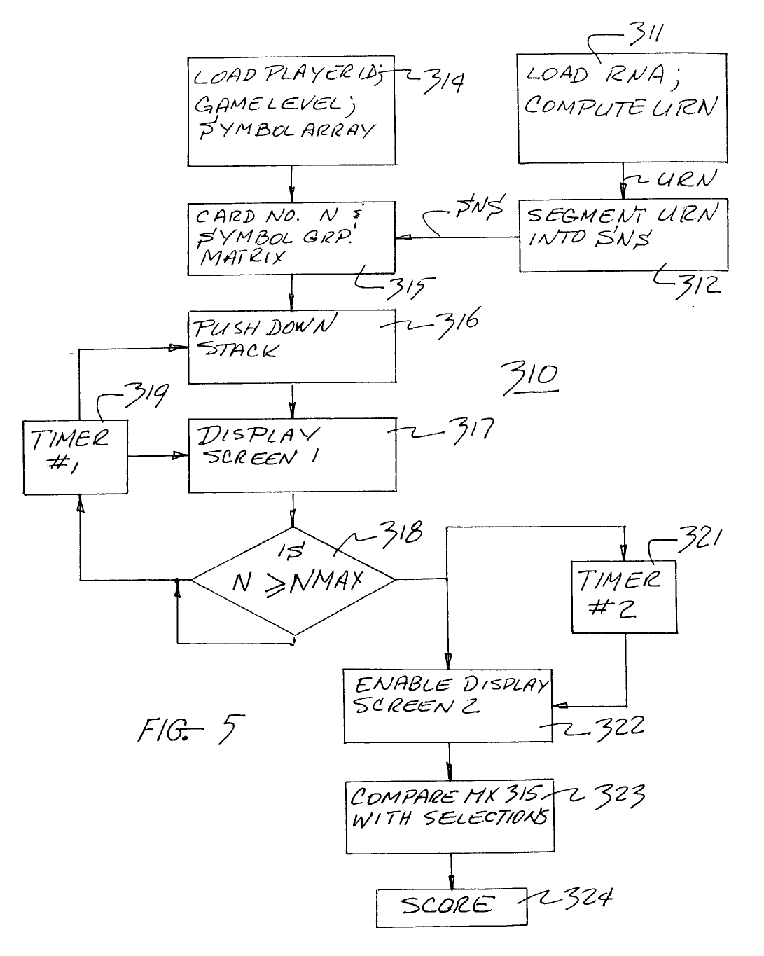

The foregoing method is particularly suited for computer assisted implementation and may be carried out on a computer network system like that now known by the name Internet, illustrated in FIGS. 4 through 7. This implementation takes benefit takes benefit of a general utility computer communication system generally designated by the numeral 210 defined by a network 211 to which all sorts of commercially available devices can be tied, exemplified herein by a group of IBM compatible personal computers 212-1 through 212-n, Apple based computers 213-1 through 213-m, one or more remotely accessible printing facilities 214-1 through 214-p, work stations 215-1 through 215-r and even hand-held devices or PDAs 216-1 through 216-s. Characteristically each of the foregoing devices includes its own communication interface and at least some internal processing capability, resulting in various levels of data processing distribution which also results in varying communication rates and demands. Universally, however, each of the devices is provided with its own internal time keeping process, either effected by a simple do-loop of circulating instructions that convert the processing switching rate to seconds and minutes or even a hardware implemented clock. Thus a time interval measuring process is decoupled from any network communication logjams in virtually all instances.

Along with these distributed processing devices the technology associated with computer communication networks also evolved the notion of a ‘server’ which takes up the many mismatches that are inherent in a pluralistic, or democratic, network generally accessible to all. Accordingly, illustrated herein is a server system generally designated by the numeral 250 configured, for example, like the Microsoft Transaction Server MTS which, typical to all processing systems, includes its own processor 252, temporary memory 253, a permanent storage or memory of some substantial capacity like a disc rack 254, and its own internal communication bus 255 connecting all these to devices like an external monitor 256 and an input device like a keyboard 257. In conventional practice the server system also includes its own communication interface 251 of some parallel capacity to communicate with network 211 and may also be provided with an Ethernet card 258 for high speed local communication with other, network independent, devices. All these are well known and commercially available, the Ethernet card 258 operating, for example, according to the teachings of U.S. Pat. No. 4,063,220 to Metcalfe et al.

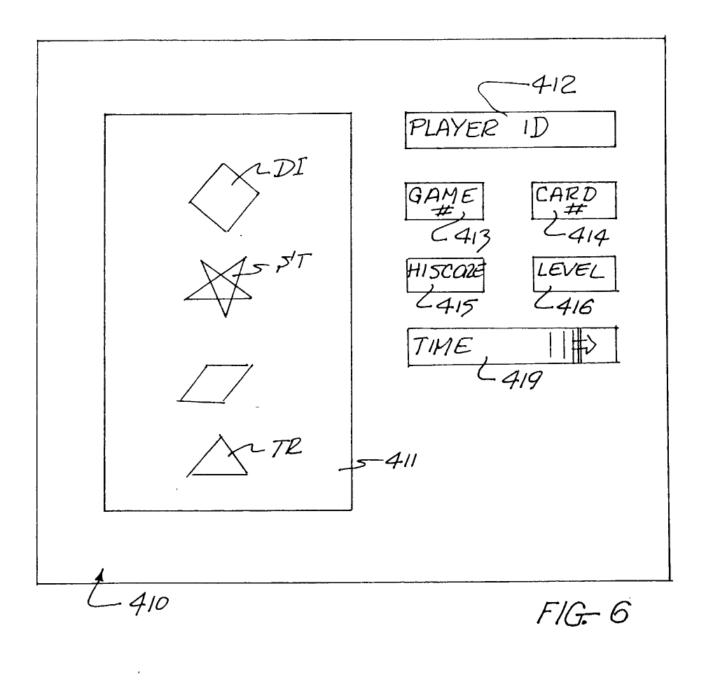

In accordance with the present invention a random number generating process or application RNA may be installed in the permanent storage 254 as a disc resident application conformed to provide a uniform random number distribution URN in accordance with one of the known techniques illustrated, for example, by the FORTRAN coded program described by P. I'Ecuyer under the title “Uniform Random Number Generator”, 1996, bearing the URL address www.info.cern.ch/asdoc/shortcorupsdr/VII/top. By reference to FIG. 5 this routine becomes part of a logical process generally designated by the numeral 310, carried out in step 311 to produce the uniformly distributed random number URN which is then broken down in step 312 into a sequence of number sets SNS randomly selecting the symbols on the face of each virtual flash card in a sequence. At the same time in step 314 the participant's identification code and level of exercise intensity are loaded to be combined in step 315 into a card stack matrix which is then parallel shifted into a display step 316, in a card-by-card sequence in the manner of a push down stack effecting a holding register for the card image which is then decoded into the screen image in step 317 for a period determined by a first timer sequence or timer do-loop 319. The cards advanced in sequence are then counted and compared against a maximum count NMAX in step 318 which directs the recycling of the timer do loop if the number of cards in the sequence is less or equal to NMAX and which stops the push-down process in step 316 when NMAX is exceeded. On that occurrence a further timer step 321 and a second screen image in step 322 are both enabled including a matrix array of the symbol options and the time remaining on the second timer. The player then selects with the use of the second image screen (shown in FIG. 7) the symbols per his or her best recollection and this recollection is compared in step 323 with the actual puch down stack. The comparison is then scored in step 324, and the score may be then utilized to advance the participant to a higher or lower level.

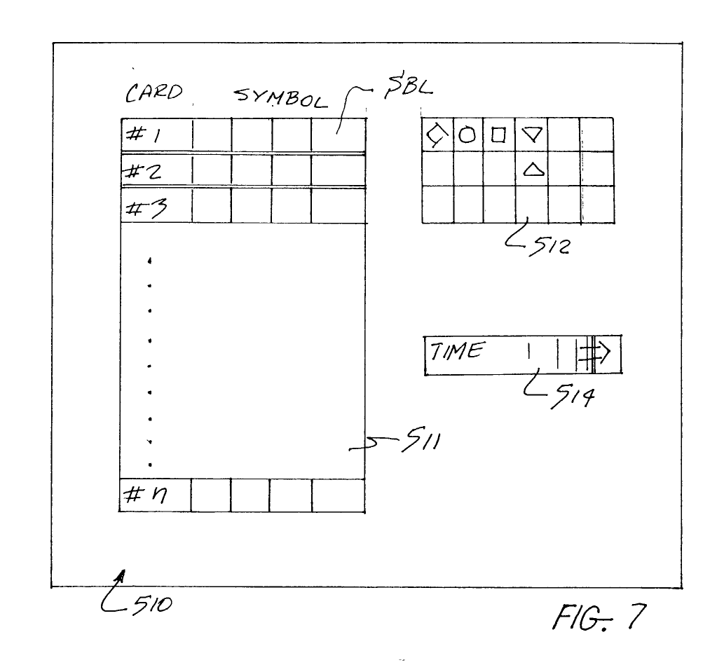

By reference to FIG. 6 the resulting video monitor image, generally at 410, presented to the participant includes a virtual flash card 411 corresponding to the symbol set pushed down into step 317 from the random number generating process. Also may be included the participant's identification 412, the game number that is played 413, the flash card number 414 in the game sequence corresponding to the count comparison N vs. NMAX in step 318, the highest score 415 and even the game level 416. The display may also include the time remaining 419 in the form of a decrementing count of the timing sequence in step 319.

When all the flash cards in a sequence are displayed, i.e., when the branching condition in step 318 is satisfied, a new monitor image illustrated in FIG. 7 is generated, shown generally at 510, including a matrix 511 corresponding to the NMAX cards times the symbol blanks SBL for each of them. Another matrix 512 provides a selection of symbols which can then be matched with the symbol blanks within a time period indicated by yet another decrementing time display 514 corresponding to the time count in step 321. Of course, at the completion of this interval a score may be posted on the video image according to step 324.

In the foregoing manner the large numerical dimensions of a random number generating process is used to advantage in maintaining the pure randomness of the process, suppressing any associative faculties of the mind in favor of the short term memory. The process can then be made available either by subscription or in the form of a disc.

Obviously, many modifications and variations can be effected without departing from the spirit of the invention instantly disclosed. It is therefore intended that the scope of the invention be determined solely by the claims appended hereto.

It is claimed:

1. A computer assisted method of training human memory comprising the steps of:
computing a substantially uniformly distributed random number sequence;
selecting a plurality of numbers in predetermined sets from said random number sequence each said number corresponding to a specific arbitrary symbol;
displaying on a monitor screen to a person viewing said screen sequentially for a first time period a group image of said symbols corresponding to the numbers in each said set;
enabling during a second time period symbol selection by said person that viewed said group images in said first time period; and
comparing the symbols selected by said person during said second time period with the symbol group images displayed during said first time periods.

2. A method according to claim 1, wherein:
said step of enabling is rendered effective upon the expiration of a third time period.

3. A method according to claim 1, wherein:
each said symbol is distinct from the other symbols.

4. A method according to claim 3, wherein:
selected ones of said symbols include geometric orientation polarity.

5. A method according to claim 2, wherein:
each said symbol is distinct from the other symbols.

6. A method according to claim 5, wherein:
selected ones of said symbols include geometric orientation polarity.

7. A computer network implemented process for providing exercise for human memory comprising the steps of
providing a network distributed processing facility with which one or more persons can communicate through the assistance of a personal computer, said facility including a stored routine for computing a substantially uniformly distributed random number;
transferring said routine to said personal computer of said person;
computing on said personal computer of said person a substantially uniformly distributed random number sequence;
selecting a plurality of numbers in predetermined sets from said random number sequence each said number corresponding to a specific arbitrary symbol;
displaying on a monitor screen of said personal computer of said person sequentially for a first time period a group image of said symbols corresponding to the numbers in each said set;
enabling during a second time period symbol selection by said person that viewed said group images in said first time period; and
comparing the symbols selected by said person at the conclusion of said second time period with the symbol group images displayed during said first time periods.

8. A method according to claim 7, wherein: said step of enabling further includes the steps of displaying a first matrix corresponding
to the number of symbols and groups displayed and a second matrix
corresponding to the variations of said symbols

9. A method according to claim 8, wherein:
said step of enabling is rendered effective upon the expiration of a third time period.

10. A method according to claim 9, wherein:
each said symbol is distinct from the other symbols.

11. A method according to claim 10, wherein:
selected ones of said symbols include geometric orientation polarity.

12. A method according to claim 11, wherein:
each said symbol is distinct from the other symbols.
